(19) United States
(12) Patent Application Publication
(10) Pub. No.: US 2020/0178484 A1
(43) Pub. Date: Jun. 11, 2020

(54) IRRIGATION CONTROL SYSTEM THAT DETECTS CLOUD COVER FROM AN ARRAY OF PHOTOVOLTAIC CELLS AND METHODS FOR SAME

(71) Applicant: HGCI, Inc., Las Vegas, NV (US)

(72) Inventor: Kaido Kert, Belmont, CA (US)

(21) Appl. No.: 16/710,437

(22) Filed: Dec. 11, 2019

Related U.S. Application Data
(60) Provisional application No. 62/777,953, filed on Dec. 11, 2018.

(51) Int. Cl. A01G 25/16; G05B 15/02; H02S 20/32; G01W 1/12

(52) U.S. Cl. CPC A01G 25/167; G01W 1/12; H02S 20/32; G05B 15/02

(57) ABSTRACT

A method for operating an irrigation control system is provided and includes receiving environmental data by the irrigation control system and receiving operational data from an array of photovoltaic cells. The method further includes determining an amount of cloud cover in the sky from the array of photovoltaic cells and calculating an evapotranspiration value for an irrigation zone associated with the irrigation control system based at least in part upon the environmental data and the operational data. The method still further includes determining an irrigation schedule for the irrigation zone based at least in part upon the evapotranspiration value and executing the irrigation schedule to irrigate the irrigation zone. An irrigation control system is also provided.

### TECHNICAL FIELD

The apparatus and methods described below generally relate to an irrigation control system that detects cloud cover from an array of photovoltaic cells. In particular, the cloud cover is determined from operational data received from photovoltaic cells and used to calculate an evapotranspiration value.

### BACKGROUND

Some conventional irrigation systems control the irrigation of an area using an irrigation schedule that is calculated based at least in part on an evapotranspiration value. However, these evapotranspiration values are not particularly accurate and adversely affect the accuracy of the irrigation schedule.

### SUMMARY

In accordance with one embodiment, a method for operating an irrigation control system is provided. The method comprises receiving operational data from an array of photovoltaic cells and determining an amount of cloud cover in the sky from the array of photovoltaic cells. The method further comprises calculating an evapotranspiration value for an irrigation zone associated with the irrigation control system based at least in part upon the operational data and determining an irrigation schedule for the irrigation zone based at least in part upon the evapotranspiration value. The method still further comprises executing the irrigation schedule to irrigate the irrigation zone.

In accordance with another embodiment, an irrigation control system comprises a fluid valve and an irrigation scheduler. The fluid valve is associated with a water source and a dispensation unit and configured to facilitate selective delivery of fluid from the water source to the dispensation unit. The irrigation scheduler comprises at least one processor configured to receive instructions which when executed by the processor cause the processor to receive environmental data by the irrigation control system and receive operational data from an array of photovoltaic cells. The instructions further cause the processor to determine an amount of cloud cover in the sky from the array of photovoltaic cells and calculate an evapotranspiration value for an irrigation zone associated with the irrigation control system based at least in part upon the environmental data and the operational data. The instructions still further cause the processor to determine an irrigation schedule for the irrigation zone based at least in part upon the evapotranspiration value and execute the irrigation schedule to irrigate the irrigation zone.

In accordance with yet another embodiment, an irrigation control system comprises an array of photovoltaic cells and a computing system. The computing system is electrically coupled with the array of photovoltaic cells and is configured to detect operational data from at least one photovoltaic cell from the array of photovoltaic cells to facilitate calculation of an evapotranspiration value based upon the operational data for use by an irrigation system.

### BRIEF DESCRIPTION OF THE DRAWINGS

It is believed that certain embodiments will be better understood from the following description taken in conjunction with the accompanying drawings in which:

FIG. 1 depicts a schematic view of an irrigation control system; and

FIG. 2 depicts a schematic view of the irrigation control system in association with an array of photovoltaic cells.

### DETAILED DESCRIPTION

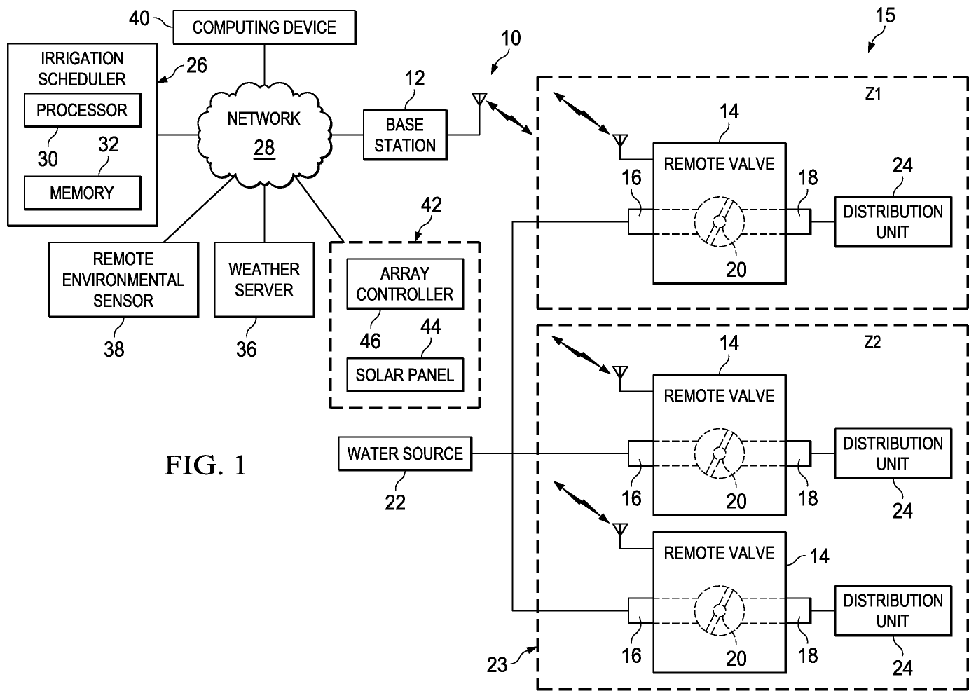

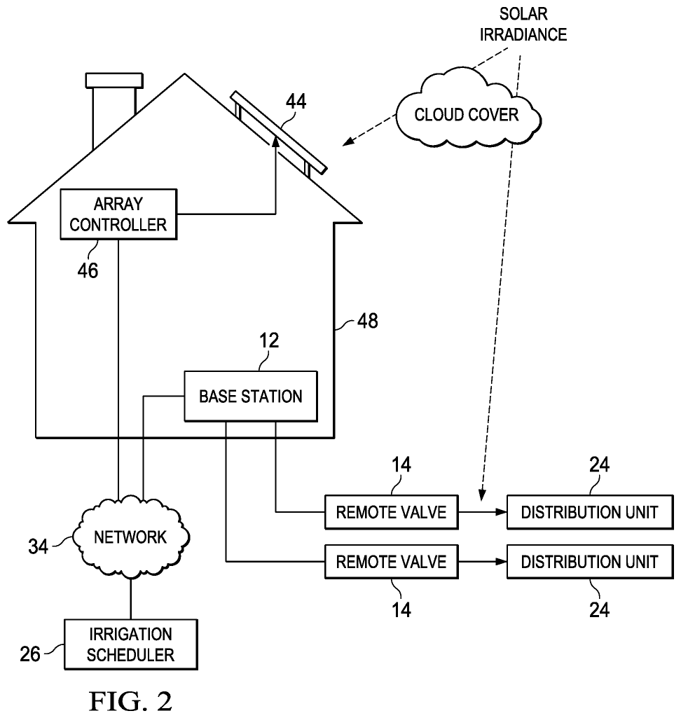

Selected embodiments are hereinafter described in detail in connection with the views and examples of FIGS. 1 and 2. An irrigation control system 10 in accordance with one embodiment is generally depicted in FIGS. 1 and 2. The irrigation control system 10 can include a base station 12 and a plurality of remote valves 14 that are distributed along an irrigation site 15, such as a consumer's home. Still referring to FIG. 1, the remote valves 14 are shown to be provided at different locations at the irrigation site 15 to provide adequate irrigation coverage.

One of the remote valves 14 will now be described and can be understood to be representative of the other remote valves 14 that are illustrated in FIG. 1. The remote valve 14 can comprise a fluid inlet 16, a fluid outlet 18, and a gate valve 20 in fluid communication with each of the fluid inlet 16 and the fluid outlet 18. The fluid inlet 16 can be coupled with a water source 22 that provides water to the fluid inlet 16. The fluid outlet 18 can be coupled with a distribution unit 24, such as a sprinkler, that facilitates dispensation of water to the area adjacent the distribution unit 24. In one embodiment, each of the fluid inlet 16 and the fluid outlet 18 can be coupled to the respective water source 22 and the distribution unit 24 with conventional garden hoses (not shown), which can enable a user to easily select the position of the remote valve 14 and the distribution unit 24 within the irrigation site 15.

The gate valve 20 can be configured for selective actuation between an opened position and a closed position to control the fluid flow from the water source 22 to the distribution unit 24. In one embodiment, the gate valve 20 can be a two position valve that operates in either a fully opened positioned or a fully closed position. In another embodiment, the gate valve 20 can be selectively variable between the fully opened position and the fully closed position such that the fluid flow through the gate valve 20 is controllable (e.g., a ball valve). The remote valve 14 can be powered by an onboard power source (not shown), such as a battery (e.g., rechargeable or disposable) or an array of photovoltaic cells, for example.

The base station 12 can be configured to transmit instructions to the remote valve 14 that selectively opens and closes the gate valve 20 to facilitate dispensation of water from the distribution unit 24 to a surrounding area, as will be described in further detail below. In one embodiment, the base station 12 and the remote valve 14 can be in wireless communication with each other. In such an embodiment, each of the base station 12 and the remote valve 14 can have respective transceivers (not shown) that support any of a variety of wireless communication protocols, such as the ZigBee protocol, for example. In another embodiment, the base station 12 and the remote valve 14 can be in wired communication with each other such as with 24 VDC control lines, for example.

Still referring to FIG. 1, one of the remote valves 14 can define a first zone Z1 and the other two remote valves 14 can define a second zone Z2. In one embodiment, the base station 12 can control operation of the remote valves 14 based upon the zone in which they are located (e.g., a zone-based irrigation strategy). It is to be appreciated that any quantity of remote valves 14 can define an irrigation zone. It is also to be appreciated that any quantity of remote valves 14 (e.g., one) can be provided at an irrigation site 15 and be controlled by the base station 12.

An irrigation scheduler 26 can be in communication with the base station 12 via a network 34 (i.e., the internet) and can control operation of the remote valves 14 based upon an irrigation schedule. The irrigation schedule can be tailored to control the watering day(s), watering times, watering duration, flow rate, or any of a variety of other operating parameters of the remote valves 14 to prevent overwatering/underwatering of a particular irrigation site or zone.

The irrigation scheduler 26 can execute the irrigation schedule by sending discrete instructions at different times to the base station 12 which can relay the instruction to the remote valve(s) 14. For example, if the irrigation schedule calls for irrigation twice a day (e.g., noon and 5 P.M.) for a particular time period (e.g., 30 minutes), the irrigation scheduler 26 can send a first instruction to the base station 12 at the first scheduled time (e.g., noon) that commands the remote valve(s) 14 to remain open for the given time period (e.g., 30 minutes). The base station 12 can, in turn, relay that instruction to the remote valve(s) 14 which causes the remote valve(s) 14 to open and then automatically close after the given time period has elapsed. The irrigation scheduler 26 can then send a second instruction to the base station 12 at the second scheduled time (e.g., 5 P.M.) that commands the remote valve(s) 14 to remain open for the given time period (e.g., 30 minutes). The base station 12 can, in turn, relay that instruction to the remote valve(s) 14 which causes the remote valve(s) 14 to open and then automatically close after the given time period has elapsed.

The irrigation scheduler 26 can have a processor 30 and a memory 32 and the irrigation schedule can be stored entirely in the memory 32. In one embodiment, the irrigation scheduler 26 can comprise a cloud-based server that is in communication with a network 34 (i.e., the internet). By sending discrete instructions from the irrigation scheduler 26 to the base station 12, the irrigation schedule does not need to be independently stored on the base station 12 or the remote valve 14. Instead, the base station 12 can serve as a pass through device that can translate the instruction(s) from the irrigation scheduler 26 into an appropriate communication protocol (e.g., Zigbee) for transmission to the remote valve(s) 14. In another embodiment, the irrigation schedule can be transmitted from the irrigation scheduler 26 to the base station 12 and stored in memory (not shown) on the base station 12 such that the base station 12 can implement the irrigation schedule without further communication with the irrigation scheduler 26. It is to be appreciated that the irrigation scheduler 26 can be any of a variety of suitable alternative computing systems.

In one embodiment, the irrigation schedule can be initially created by a user from a computing device 40 (e.g., a smart phone, a tablet, a laptop computer, or a desktop computer) that is in communication with the irrigation scheduler 26 via the network 34. The computing device 40 can facilitate display of a graphical user interface that enables the user to enter various parameters for the irrigation schedule (e.g., watering day(s), watering times, watering duration, and/or flow rate). Those parameters are transmitted to the irrigation scheduler 26 and stored in the memory 32 as the irrigation schedule. In another embodiment, the irrigation scheduler 26 can automatically create the irrigation schedule based upon detected environmental conditions.

As will be described in further detail below, the irrigation scheduler 26 can adjust the irrigation schedule periodically (e.g., hourly or daily) to accommodate for changes in environmental conditions that might affect the need for irrigation, such as, for example, a weather forecast, historical weather data, evapotranspiration data, predicted rainfall, cloud cover, or any other variable that might affect the need for irrigation.

The irrigation scheduler 26 can be in communication with a weather server 36 via the network 34. The weather server 36 can provide weather data to the irrigation scheduler 26 that is used to generate and/or adjust the irrigation schedule. The weather data can include predictive weather data (i.e., from a predictive model) that can forecast the upcoming weather for the irrigation site 15. The irrigation scheduler 26 can use this predictive data to adjust the irrigation schedule to prevent overwatering/underwatering of the irrigation site 15. For example, if the predictive weather model indicates that there is a 100% chance of rain over the next two days, the irrigation scheduler 26 might suspend the next two days of scheduled irrigation events to prevent overwatering of the irrigation site 15. It is to be appreciated that each of the base station 12, the irrigation scheduler 26 and the weather server 36 can be connected to the network 34 via wired or wireless data transmission links such as Ethernet, TCP/IP, and/or WiFi.

The irrigation scheduler 26 can also be in communication, via the network 34, with a remote environmental sensor 38 that communicates other types of environmental data to the irrigation scheduler 26 for use in determining the irrigation schedules. In one embodiment, the remote environmental sensor 38 can comprise a rainfall sensor, a wind sensor, a soil moisture sensor, a humidity sensor, or a weather sensor, or some combination thereof. It is to be appreciated, however, that the remote environmental sensor 38 can be any device that is capable of communicating environmental data to the irrigation scheduler 26 for using in determining the irrigation schedule.

The remote environmental sensor 38 can be deployed at or near the irrigation site 15 to detect the environmental conditions at the site. In one embodiment, the remote environmental sensor 38 can be a network enabled device that can itself connect the network 34 (e.g., via Wi-Fi) and that communicates with a router or other device to communicate the environmental data to the irrigation scheduler 26. In another embodiment, the remote environmental sensor 38 can wirelessly communicate with the base station 12 such that the base station 12 is responsible for accessing the network 34 to transmit the environmental data to the irrigation scheduler.

The irrigation scheduler 26 can be configured to determine an evapotranspiration value for the irrigation site 15 that is used in determining/adjusting the irrigation schedule. Evapotranspiration can be understood to mean the process by which water is transferred from soil to the atmosphere by evaporation from the soil and other surfaces and by transpiration from plants. As such, the evapotranspiration at the irrigation site 15 can be affected by different environmental factors, such as, for example, the amount of cloud cover in the sky which can affect the amount of sunlight that is imparted to the irrigation site 15 thus encouraging evapotranspiration.

The irrigation scheduler 26 can be configured to determine an amount of cloud cover in the sky which can be used, at least in part, to calculate the evapotranspiration value. In one embodiment, the irrigation scheduler 26 can determine the amount of cloud cover in the sky based upon operational data provided from a solar power system 42, as illustrated in FIG. 1. The solar power system 42 can include an array of photovoltaic cells (e.g., a solar panel) 44 and an array controller 46 that is in communication with the irrigation scheduler 26 via the network 34.

The solar panel 44 can facilitate the conversion of solar energy into electric power for delivery to a power system such as a home electrical grid or a distribution/transmission grid. The solar panel 44 can be provided at or near the irrigation site 15 controlled by the irrigation scheduler 26 such that the solar irradiance imparted to the solar panel 44 can represent the solar irradiance experienced at the irrigation site 15. In one embodiment, as illustrated in FIG. 2, the solar panel 44 can be mounted atop a dwelling structure 48, such as a house or commercial building, located at the irrigation site 15. In another embodiment, the solar panel 44 can be a stand-alone panel located near the irrigation site 15 such as is often deployed by a power company for generating power for delivery to an electrical grid. In some embodiments, the solar panel 44 can be pivotable with respect to its mounting location. In these embodiments, the array controller 46 can be configured to control pivoting of the solar panel 44 to track the movement of the sun across the sky.

The amount of power that is delivered from the solar panel 44 (e.g., the power output) can depend upon the intensity of the solar irradiance (i.e., from the sun) that is imparted to the solar panel 44. The intensity of the solar irradiance can vary depending upon the time of day, the time of year, the amount of current cloud cover, or any of a variety of other factors.

The array controller 46 can be in communication with the irrigation scheduler 26 and can transmit operational data about the solar panel 44 to the irrigation scheduler 26 to facilitate calculation of the cloud cover in the sky. In one embodiment, the array controller 46 can transmit the current power output of the solar panel 44, as power output data, to the irrigation scheduler 26. The irrigation scheduler 26 can compare the current power output of the solar panel 44 to a maximum available power output for the solar panel 44. The difference between the current power output and the maximum available power output can indicate the amount of cloud cover in the sky. For example, if the current power output value of the solar panel 44 is about 70% of the maximum available power output, then the irrigation scheduler 26 can determine that there is about 30% cloud cover in the area.

The maximum available power output of the solar panel 44 can be understood to be the power output that the solar panel 44 is capable of generating when every cell in the solar panel 44 is fully operational (e.g., no malfunctioning cells) and the solar panel 44 is exposed to full sun (e.g., no cloud cover) in light of the current time of day, day of the year, and geographic location. It is to be appreciated that the amount of irradiance from the sun can be affected by the time of day, time of year, and geographic location in which the cloud cover is being determined such that the maximum available output power from the solar panel 44 can be different depending on the time of day, time of year, and geographic location. For example, the irradiance from the sun can be greater on the solar panel 44 at noon as opposed to in the early morning or late afternoon. Similarly, the irradiance from the sun can be greater on a summer day than on a winter day (when the sun is further from the earth). The maximum available power output can therefore be an actual maximum available power output from the solar panel 44 that is based upon the time of day and day of the year rather than the maximum rated power output of the solar panel 44. As such, when the irrigation scheduler 26 is determining the cloud cover from the power output data from the array controller 46, the power output data can include the maximum available power output for the time of day and the day of the year in which the calculation is taking place.

The maximum available power output of the solar panel 44 for the different times of day and days of the year can be stored in a memory (not shown) of the array controller 46 (e.g., as a lookup table) and transmitted to the irrigation scheduler 26 as part of the power output data (e.g., operational data) via the network 34 for use in determining the cloud cover in the sky. In one embodiment, the maximum available power output can be transmitted from the array controller 46 to the irrigation scheduler 26 as needed for determining the cloud cover in the sky. In such an embodiment, the irrigation scheduler 26 can identify the time of day and day of the year for which the cloud cover is being determined and the array controller 46, in response, can transmit the maximum available power output for that time of day and day of time to the irrigation scheduler 26. In another embodiment, the entire lookup table can be transmitted from the array controller 46 to the irrigation scheduler 26, in bulk, which is stored in the memory 32 of the irrigation scheduler 26. In such an embodiment, the irrigation scheduler 26 identifies the maximum available power output for a given time of day and day of the year without having to repeatedly request the information from the array controller 46.

In one embodiment, the maximum available power output of the solar panel 44 can be calculated for the different times of day and days of the year based upon the physical parameters of the solar panel 44 (e.g., the angle of the solar panel 44, the footprint of the solar panel 44, the number of defective cells) as well as historical environmental data (e.g., the amount of irradiance from the sun for the time of day and day of the year). In another embodiment, the array controller 46 can extrapolate the maximum available power output for the different times of day and days of the year based upon historical power output data that is collected by the array controller 46 over time. In such an example, the peak power output from the solar panel 44 for the different times of day and days of the year can be used as the maximum available power output for the solar panel 44.

In some embodiments, the solar panel 44 and the array controller 46 might be controlled (e.g., owned/operated) by a third party provider such as a neighboring building or the power company such that the operational data from the array controller 46 might not be readily available to the owner of the irrigation control system 10. In such an embodiment, the operational data can be provided to the irrigation scheduler 26 through an agreement (e.g., subscription) with the third party.

It is to be appreciated that the evapotranspiration value for the irrigation site 15 can be calculated according to certain environmental conditions in addition to the calculated cloud cover in the sky, such as, for example, soil moisture, amount of recent rainfall, wind speed magnitude and direction, humidity, soil type, plant type, or plant density. Some of these environmental conditions, such as, for example, soil moisture, humidity, and wind speed magnitude and direction can be obtained from the environmental sensors described above. Other environmental conditions, such as, for example, soil type, plant type, and plant density can be provided to the irrigation scheduler 26 as part of the setup process for the irrigation control system 10.

It is also to be appreciated that using cloud cover in the sky to determine an evapotranspiration value can provide a more precise evapotranspiration value for use in establishing/adjusting an irrigation schedule that certain conventional arrangements. In particular, as the cloud cover increases or decreases, the calculated evapotranspiration value can vary accordingly such that the amount and/or length of the upcoming scheduled irrigations increase or decrease, respectively, to accommodate for the cloud cover which can provide for more effective irrigation of the irrigation site 15 than currently available in conventional arrangements.

The foregoing description of embodiments and examples of the disclosure has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate the principles of the disclosure and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A method for operating an irrigation control system, the method comprising:
receiving operational data from an array of photovoltaic cells;
determining an amount of cloud cover in the sky from the array of photovoltaic cells based at least in part upon the operational data;
calculating an evapotranspiration value for an irrigation zone associated with the irrigation control system based at least in part upon the amount of cloud cover in the sky;
determining an irrigation schedule for the irrigation zone based at least in part upon the evapotranspiration value; and
executing the irrigation schedule to irrigate the irrigation zone.

2. The method of claim 1 wherein receiving operational data comprises receiving power output data from the array of photovoltaic cells.

3. The method of claim 2 wherein determining the amount of cloud cover comprises, for at least one of the photovoltaic cells of the array, comparing the power output data with adjacent photovoltaic cells of the array.

4. The method of claim 1 wherein executing the irrigation schedule to irrigate the irrigation zone comprises activating a fluid valve associated with a water source and a dispensation unit such that fluid is delivered from the water source, through the fluid valve and out of the dispensation unit.

5. The method of claim 1 wherein the array of photovoltaic cells are at a location remote from the irrigation zone.

6. The method of claim 1 further comprising receiving environmental data by the irrigation control system and wherein the evapotranspiration value system is based at least in part upon the environmental data and the operational data.

7. The method of claim 6 wherein receiving environmental data comprises receiving environmental data from at least one environmental sensor.

8. The method of claim 7 wherein the at least one environmental sensor comprises one or more of a rainfall sensor, a wind sensor, a soil moisture sensor, a humidity sensor, and a weather sensor.

9. The method of claim 6 wherein receiving environmental data comprises receiving predictive weather data from a predictive weather model.

10. An irrigation control system comprising:
a fluid valve associated with a water source and a dispensation unit and configured to facilitate selective delivery of fluid from the water source to the dispensation unit; and
an irrigation scheduler comprising at least one processor configured to receive instructions which when executed by the processor cause the processor to:
receive environmental data by the irrigation control system;
receive operational data from an array of photovoltaic cells;
determine an amount of cloud cover in the sky from the array of photovoltaic cells;
calculate an evapotranspiration value for an irrigation zone associated with the irrigation control system based at least in part upon the environmental data and the operational data;
determine an irrigation schedule for the irrigation zone based at least in part upon the evapotranspiration value; and
execute the irrigation schedule to irrigate the irrigation zone.

11. The irrigation control system of claim 10 wherein causing the processor to receive operational data comprises causing the processor to receive power output data from the array of photovoltaic cells.

12. The irrigation control system of claim 11 wherein causing the processor to determine the amount of cloud cover comprises, for at least one of the photovoltaic cells of the array, causing the processor to compare the power output data with adjacent photovoltaic cells of the array.

13. The irrigation control system of claim 10 wherein causing the processor to execute the irrigation schedule to irrigate the irrigation zone comprises causing the processor to activate a fluid valve associated with a water source and a dispensation unit such that fluid is delivered from the water source, through the fluid valve and out of the dispensation unit.

14. The irrigation control system of claim 10 wherein the array of photovoltaic cells are at a location remote from the irrigation zone.

15. The irrigation control system of claim 10 wherein the instructions further cause the processor to receive environmental data by the irrigation control system and wherein the evapotranspiration value system is based at least in part upon the environmental data and the operational data.

16. The irrigation control system of claim 15 wherein receiving environmental data comprises receiving predictive weather data from a predictive weather model.

17. The irrigation control system of claim 10 wherein the irrigation scheduler comprises an onboard non-transitory computer readable medium for storing the instructions thereon.

18. The irrigation control system of claim 10 wherein the irrigation scheduler comprises a cloud based server that is remote from a base station and configured to transmit the instructions to the base station.

19. An irrigation control system comprising:
an array of photovoltaic cells; and
a computing system electrically coupled with the array of photovoltaic cells and configured to detect operational data from at least one photovoltaic cell from the array of photovoltaic cells to facilitate calculation of an evapotranspiration value based upon the operational data for use by an irrigation system.

20. The irrigation control system of claim 19 wherein the operational data comprises power output data of the array of photovoltaic cells.
